(19) United States
(12) Patent Application Publication
(10) Pub. No.: US 2016/0021530 A1
(43) Pub. Date: Jan. 21, 2016

(54) Method and Apparatus for Selectively Granting or Denying Mobile Applications Access to Cellular Networks

(71) Applicant: Google Technology Holdings LLC, Mountain View, CA (US)

(72) Inventors: Naveen Aerrabotu, Gurnee, IL (US); Deng-Feng Jiang, Round Lake, IL (US); Girish B. Koppad, Sunnyvale, CA (US); Sreenivasulu Rayanki, Grayslake, IL (US); Nitya K. Reddy, Waukegan, IL (US)

(21) Appl. No.: 14/335,101

(22) Filed: Jul. 18, 2014

(51) Int. Cl. H04W 8/22

(52) U.S. Cl. CPC H04W 8/22

(57) ABSTRACT

The present disclosure describes methods and a wireless mobile device for selectively granting or denying mobile applications (“apps”) access to a cellular network. In various implementations, a wireless mobile device having both WiFi capability and cellular data capability receives a data packet from an app executing on the wireless mobile device. If the app is not whitelisted and the wireless mobile device is not connected to a WiFi network, the wireless mobile device drops the data packet. If, on the other hand, the app is whitelisted, the wireless mobile device transmits the data packet over the cellular network.

### TECHNICAL FIELD

The present disclosure is directed to wireless communication and, more particularly, to a method and apparatus for selectively granting or denying mobile applications access to cellular networks.

### BACKGROUND

While the trend in mobile communication is moving more and more toward data-centric plans, there is still a considerable market for lower-cost cellular plans that are primarily voice-based. This market persists in spite of the fact that the most popular devices being sold are so-called smartphones. In other words, there are many users who would like to own a smartphone, use many of its features, including internet access over WiFi, but who are willing to forego the use of data (e.g., refrain from accessing the internet) over cellular networks.

There are situations, however, in which cellular carriers may wish to allow subscribers to have some access the internet via their cellular networks even if those subscribers do not have fully operable data plans.

### DRAWINGS

While the appended claims set forth the features of the present techniques with particularity, these techniques may be best understood from the following detailed description taken in conjunction with the accompanying drawings of which:

FIG. 1 is a block diagram of a communication system according to an embodiment;

FIG. 2 is a block diagram of a representative wireless mobile device according to an embodiment;

FIG. 3 is a block diagram of a software architecture of a wireless mobile device according to an embodiment;

FIG. 4 is a message sequence diagram illustrating the interaction between the different components of FIG. 3 in an embodiment;

FIG. 5 is a process flow diagram illustrating how the wireless mobile device drops data packets before they can be transmitted over a cellular network, in an embodiment;

FIG. 6 is a process flow diagram illustrating how the wireless mobile device drops data packets before they can be transmitted over a cellular network in another embodiment; and

FIG. 7 is a process flow diagram illustrating how the wireless mobile device grants or denies explicit requests to access to the cellular network based on whether requesting apps are whitelisted.

### DESCRIPTION

Turning to the drawings, wherein like reference numerals refer to like elements, techniques of the present disclosure are illustrated as being implemented in a suitable environment. The following description is based on embodiments of the claims and should not be taken as limiting the claims with regard to alternative embodiments that are not explicitly described herein.

The present disclosure describes methods and a wireless mobile device for selectively granting or denying mobile applications (“apps”) access to a cellular network. In various embodiments, a wireless mobile device having both WiFi capability and cellular data capability receives a data packet from an app executing on the wireless mobile device. If the app is not whitelisted and the wireless mobile device is not connected to a WiFi network, the wireless mobile device drops the data packet. If, on the other hand, the app is whitelisted, the wireless mobile device transmits the data packet over the cellular data network.

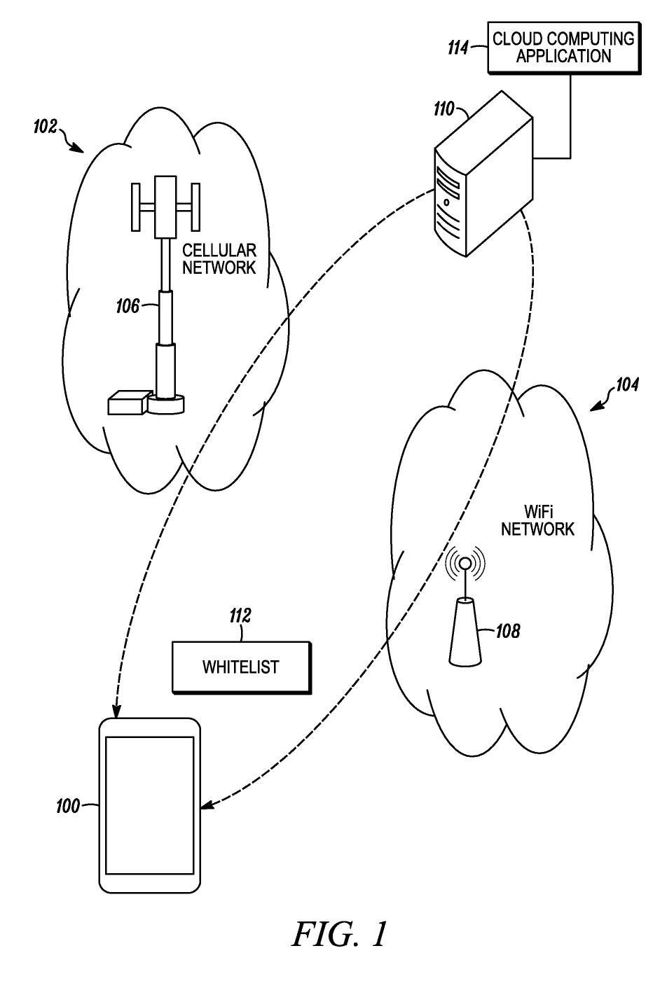

Turning to FIG. 1, a wireless mobile device 100 according to an embodiment is configured to communicate wirelessly with both a cellular network 102 (such one that follows standards set by the Third Generation Partnership Project (“3GPP”)) and a and a WiFi network 104 (such as an Institute of Electrical and Electronics Engineers (“IEEE”) 802.11x network). The cellular network 102 includes one or more base stations, represented by the base station 106 shown in FIG. 1. The WiFi network 104 includes one or more access points, represented by the access point 108 shown in FIG. 1. Possible implementations of the wireless mobile device 100 include a cell phone (such as a smartphone), a tablet computer, and laptop computer. The wireless mobile device 100 is configured to carry out the various methods described herein.

According to an embodiment, the wireless mobile device 100 is capable of communicating with a remotely-located server 110 over one or both of the cellular network 102 and the WiFi network 104 in order to receive, from a cloud computing application 114, a whitelist 112 of apps (or an update to the whitelist 112) that are permitted to access cellular networks using the wireless mobile device 100. In one embodiment, the cloud computing application 114 executes on a cloud computing platform such as the Google® App Engine and communicates with the device 100 via Google® Cloud Messaging.

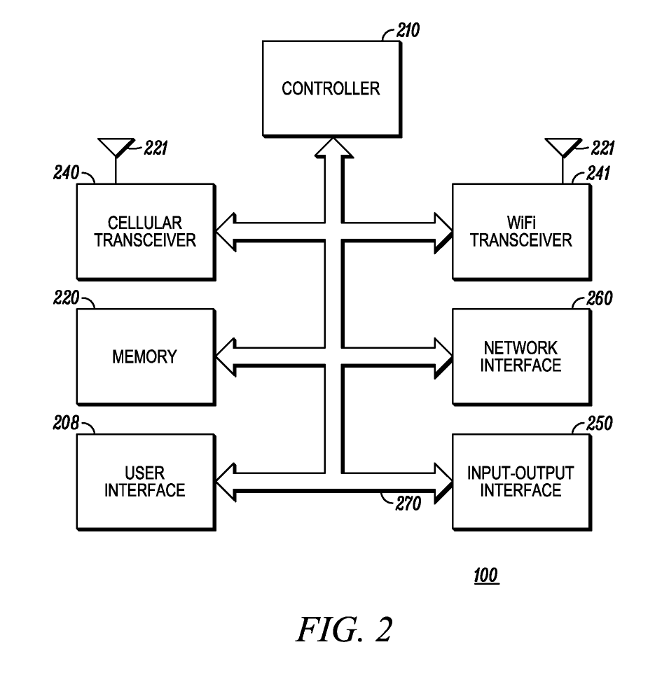

FIG. 2 illustrates possible implementation of the wireless mobile device 100. The wireless mobile device 100 (“the device 100”) includes a user interface 208, a controller 210, a memory 220 (which can be implemented as volatile memory or non-volatile memory, Read-Only Memory (“ROM”) or Random Access Memory (“RAM”), or a mix of these types), a cellular transceiver 240, a WiFi transceiver 241, an input-output interface 250, a network interface 260, and one or more antennas 221. The controller 210 retrieves instructions from the memory 220 and operates according to those instructions to provide outgoing data to and receive incoming data from the cellular transceiver 240 and the WIFi transceiver 241. The controller 210 also receives data from and sends data to external devices via the input-output interface 250.

During operation, one or more of the transceivers 240 and 241 receives data from the controller 210 and transmits Radio Frequency (“RF”) signals representing the data via one or more of the antennas 221. Similarly, each transceiver receives RF signals via one or more of the antennas 221, converts the signals into the appropriately-formatted data, and provides the data to the controller 210.

Each of the elements of the device 100 is communicatively linked to the other elements via data pathways 270. Possible implementations of the data pathways 270 include wires, conductive pathways on a microchip, and wireless connections. Possible implementations of the controller 210 include a microprocessor, a microcontroller, and a digital signal processor.

Referring again to FIG. 1, the various embodiments described herein provide a mechanism for the wireless mobile device 100 to grant or deny an app internet access over the cellular network 102. The identity of the apps are permitted to access the internet over cellular network 102 is maintained in the whitelist 112. The whitelist 112 can be pre-configured on the device 100 (i.e., pre-stored in the memory 220) and updated from the cloud computing platform 114. If the device 100 is connected to a WiFi network (e.g., the WiFi network 104), and an app on the device 100 makes an explicit request for data access over cellular network 102, the device 100 denies the app access unless the app is on the whitelist 112. In other words, only whitelisted apps that explicitly request cellular data access will be granted access to the cellular network 102. If the device 100 is not connected to a WiFi network, then the device 100 will only allow whitelisted apps to obtain any sort of data access (i.e., data access to the cellular network 102).

According to an embodiment, one or more of the whitelisted apps is configured to assist the mobile wireless device 100 during voice handovers between WiFi networks (e.g., the WiFi network 104) and cellular networks (e.g., the cellular network 102). For example, assume that a user, upon unboxing and powering up the device 100, selects (via the user interface 208) a low-cost plan that includes unlimited voice and texting, but does not include any cellular data. As the device 100 is being provisioned from the cellular network 102, the device 100 contacts the cloud computing application 114, which transmits the whitelist 112 to the device 100. The device 100 then disables cellular data access for all apps on the device 100; except for an app provided by the carrier specifically to connect to the carrier's network in order to maintain the state of the call to perform handovers from WiFi to cellular with precision.

In another embodiment, this concept may be extended to provide data access to other apps to offer newer packages and plans. For example, assume the device 100 is preconfigured with the following packages: a Social package, in which the Facebook®, and Google+® apps are permitted access to the cellular network 102, and a Navigation package, in which the Google® Maps and Waze® apps are permitted access to the cellular network. At some point in time, the carrier may partner with Twitter® and may wish to extend the Social package to include Twitter®. The carrier could do this by updating whitelist 112 (i.e., add Twitter® to the Social package) and providing the update to the device 100 from the cloud computing application 114 via the cellular network 102. In some embodiments, such a change (e.g., adding Twitter® to Social package) can be restricted to only a pool of users or to a pool of devices. This scalability and flexibility may be realized with cloud computing platforms such as the Google® App Engine or Amazon® EC2.

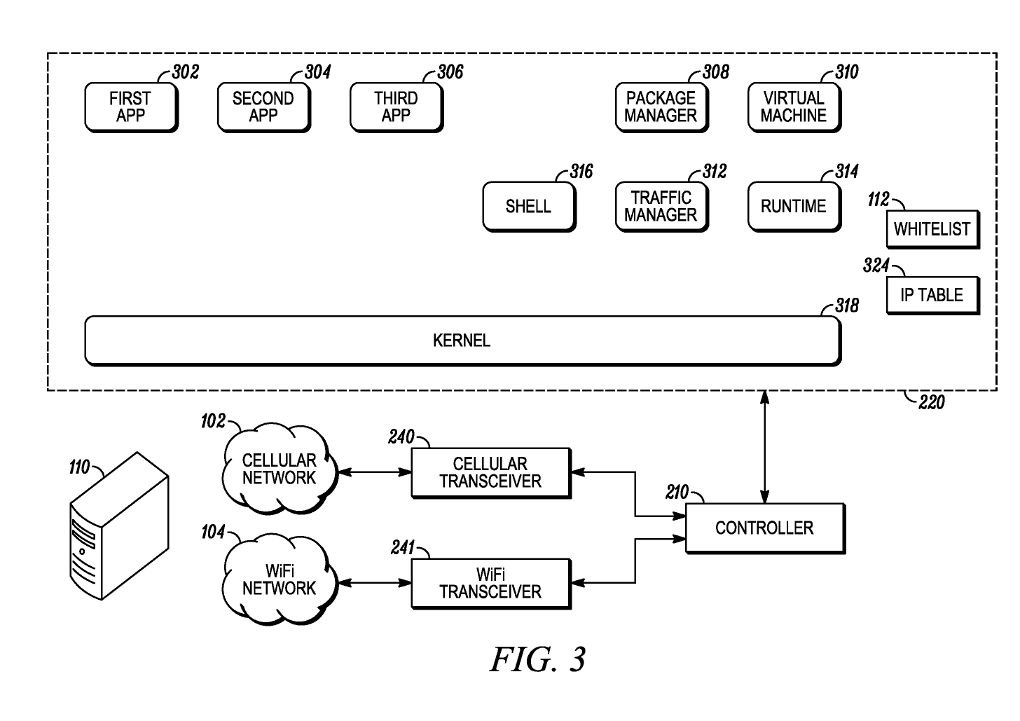

Turning to FIG. 3, in an embodiment, the controller 210 of the device 100 executes several software components, which generally reside in the memory 220 (e.g., in RAM during execution). Such software includes a first app 302, a second app 304, a third app 306, a package manager 308, a virtual machine 310 (e.g., an Android Virtual Machine), a traffic manager 312, a runtime 314, a shell 316, and a kernel 318. In one embodiment, the kernel 318 is a Linux-based Kernel configured according to an Android® operating system, the runtime 314 is an Android® runtime, the virtual machine (“VM”) 310 is a Darvik VM, and the shell 316 is an Android® shell.

Continuing with FIG. 3, the controller 210 also accesses data stored the memory 220 (e.g., in either RAM or ROM) in order to carry out instructions according to the software components. Such data includes the whitelist 112 and an Internet Protocol (“IP”) table 324. In some embodiments, the whitelist 112 is stored on the remote server 110 that the controller 210 accesses via the cellular network 102 or the WiFi network 104.

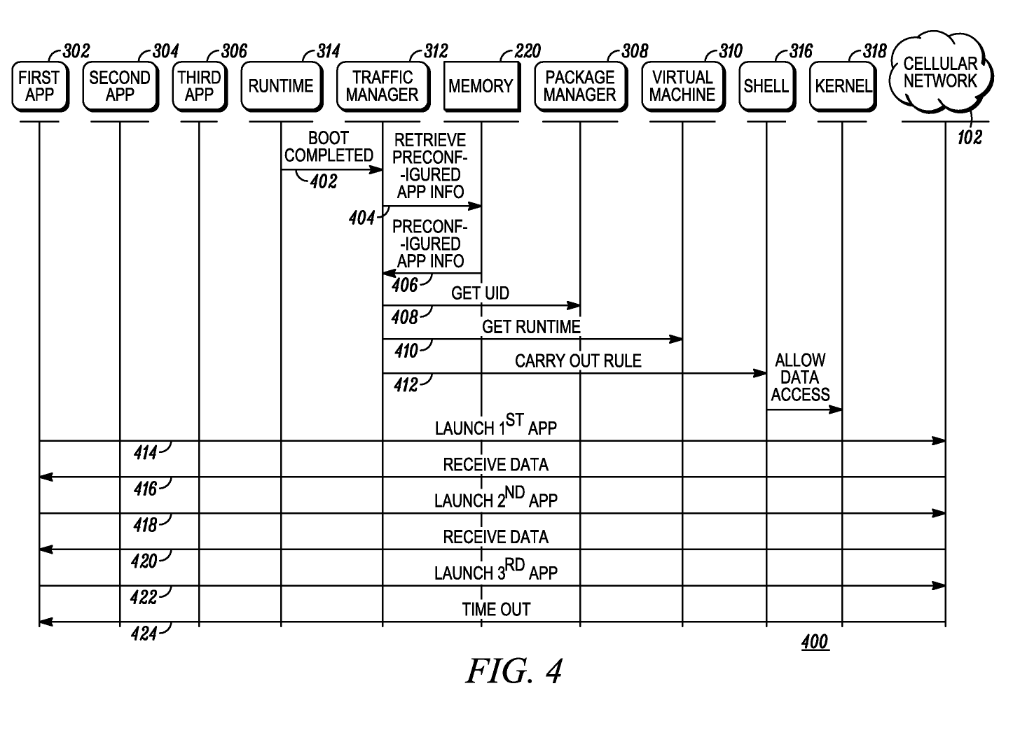

Turning to FIG. 4, a message sequence diagram 400 illustrates the interaction between the different components of FIG. 3 in an embodiment. Each of the actions carried out by the components is physically carried out by the controller 210. At 402, the runtime 314 informs the traffic manager 312 that the initial boot of the device 100 is complete. At 404 and 406, the traffic manager 312 retrieves the whitelist 112 from the memory 220 (e.g., persistent storage or ROM). In this example, it is assumed that the user has signed up for a package that includes the first app 302 and the second app 304 (e.g., a Social Package that only allows Facebook® & Google+® to communicate over the cellular network 102). At 408, the traffic manager 312 retrieves Universal Identifier (“UID”) (or App Id) for each of the apps of the package from the package manager 308. In an embodiment, the traffic manager 312 uses the UIDs to map app information to the requirements of the kernel 318 (e.g., Android® level application information to Linux Kernel requirements). At 410, the traffic manager 312 requests an instance of the virtual machine 310 to execute native commands (e.g., from Java®) directly without translation or interpretation. At 412, the traffic manager 312 execute interacts with the shell 316 to update the IP table 324. For example, in a Linux embodiment, with the first app 302 being a Facebook® app and the second app 304 being a Google+ app, the traffic manager 312 might execute the following shell commands:

iptables-I OUTPUT 1-o rmnet0-m owner—uid-owner root-j ACCEPT

iptables-I OUTPUT 2-o rmnet0-m owner—uid-owner<Facebook uid>-j ACCEPT

iptables-I OUTPUT 3-o rmnet0-m owner—uid-owner<Google+uid>-j ACCEPT

iptables-I OUTPUT 4-j DROP

Once the commands have been executed, the kernel 318 is configured to guard the data flow over the cellular network 102 (interface name: rmnet0) and to drop packets at the device level for all apps except for the first app 302 and the second app 304 (e.g., Facebook® and Google+®).

At 414, the user launches the first app 302 (e.g., launches a Facebook® app). The first app 302 sends packets, which the kernel 318 permits to be sent out over the cellular network 102. At 416, the first app 302 receives incoming packets from the cellular network 102 (e.g., a Facebook® server transmits web pages to the Facebook® app so that the user can view the user's wall and friend's postings). At 418, the user launches the second app 304 (e.g., launches a Google+® app). The second app 304 sends packets, which the kernel 318 permits to be sent out over the cellular network 102. At 420, the second app 302 receives incoming packets from the cellular network 102 (e.g., a Google+® server transmits web pages to the Google+® app so that the user can view the user's wall and friend's postings). At 422, the user launches the third app 306 (e.g., a YouTube® app). At 424, the third app 306 sends packets destined to be sent over the cellular network 102, but the kernel 318 drops these packets based on the rules set forth in the IP table 324—rules which were implemented based on the whitelist 322. The third app 306 therefore times out.

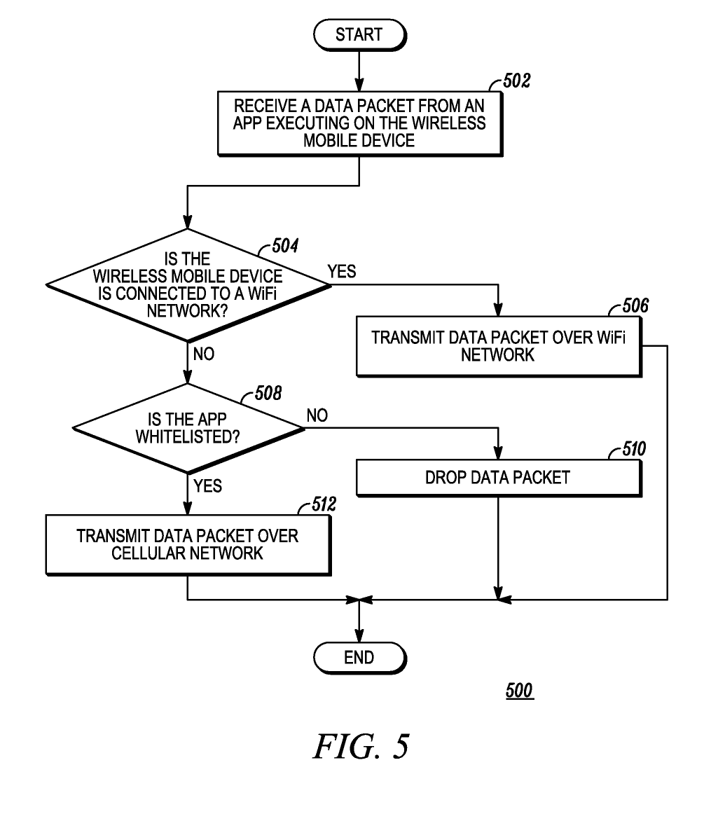

Turning to FIG. 5, a process flow diagram 500 illustrates how the device 100 drops data packets before they can be transmitted over the cellular network 104, in an embodiment. At block 502, the wireless terminal 100 receives a data packet from an app executing on the wireless mobile device 100. If, at block 504, the wireless mobile device 100 is connected to a WiFi network (e.g., the WiFi network 104), then the process moves to block 506, at which the wireless mobile device 100 transmits the data packet over WiFi network 104. If, at block 504, the wireless mobile device 100 is not connected to a

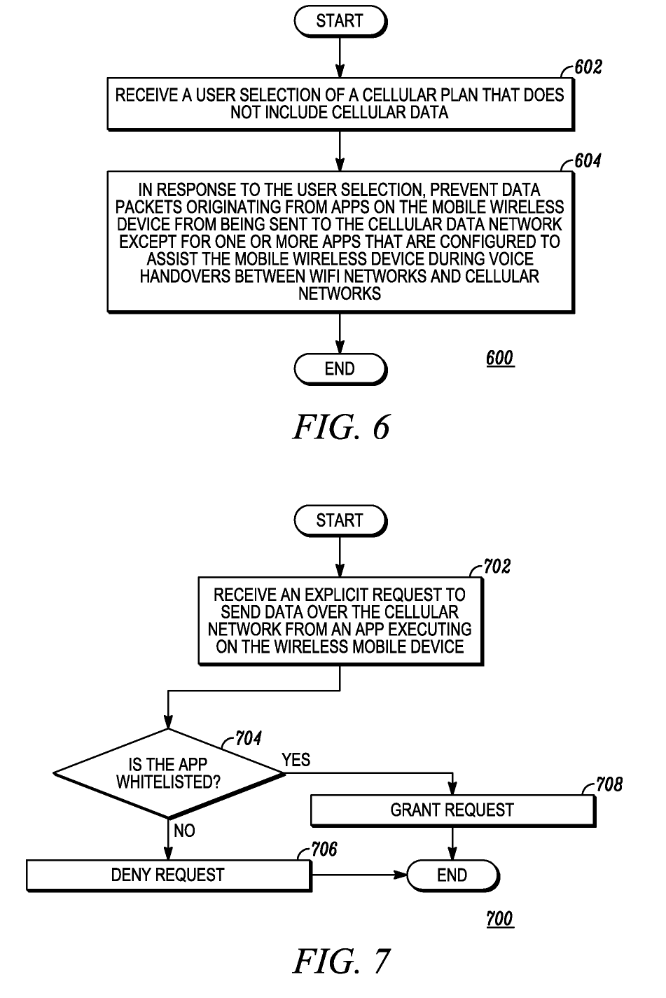

Turning to FIG. 6, a process flow diagram 600 illustrates how the device 100 drops data packets before they can be transmitted over the cellular network 104, in another embodiment. At block 602, the wireless terminal 100 receives a user selection of a cellular plan that does not include cellular data. At block 604, in response to the user selection, the wireless mobile device 100 prevent data packets originating from apps on the mobile wireless device 100 from being sent to the cellular data network, except for one or more apps that are configured to assist the mobile wireless device 100 during voice handovers between WiFi networks and cellular networks. Other actions that the device 100 carries out in an embodiment include receiving data packets from an app on the wireless mobile device 100 (e.g., the first app 302, which could be a carrier-provided app), wherein the data packets include state information of a voice call in which the wireless mobile device is participating (e.g., via the cellular network 102), and transmitting the data packets over the cellular network 102. The device 100 could then transition the call from the WiFi network 104 to the cellular network 102. If another app (e.g., the second app 304) attempts to send packets to the cellular network 102, the device (i.e., the kernel 318) drops those packets.

Turning to FIG. 6, a process flow diagram 600 illustrates how the device 100 drops data packets before they can be transmitted over the cellular network 104, in another embodiment. At block 602, the wireless terminal 100 receives a user selection of a cellular plan that does not include cellular data. At block 604, in response to the user selection, the wireless mobile device 100 prevent data packets originating from apps on the mobile wireless device 100 from being sent to the cellular data network, except for one or more apps that are configured to assist the mobile wireless device 100 during voice handovers between WiFi networks and cellular networks. Other actions that the device 100 carries out in an embodiment include receiving data packets from an app on the wireless mobile device 100 (e.g., the first app 302, which could be a carrier-provided app), wherein the data packets include state information of a voice call in which the wireless mobile device is participating (e.g., via the cellular network 102), and transmitting the data packets over the cellular network 102. The device 100 could then transition the call from the WiFi network 104 to the cellular network 102. If another app (e.g., the second app 304) attempts to send packets to the cellular network 102, the device (i.e., the kernel 318) drops those packets.

In view of the many possible embodiments to which the principles of the present discussion may be applied, it should be recognized that the embodiments described herein with respect to the drawing figures are meant to be illustrative only and should not be taken as limiting the scope of the claims. Therefore, the techniques as described herein contemplate all such embodiments as may come within the scope of the following claims and equivalents thereof.

We claim:

1. A method on a wireless mobile device having both WiFi capability and cellular data capability, the method comprising:
receiving a data packet from an app executing on the wireless mobile device;
if the app is not whitelisted and the wireless mobile device is not connected to a WiFi network, dropping the data packet; and
if the app is whitelisted, transmitting the data packet over a cellular network.

2. The method of claim 1, wherein receiving a data packet from an app comprises receiving the data packet from a first app, which is whitelisted, the method further comprising:
transmitting the data packet from the first app over the cellular network;
receiving a data packet from a second app, which is not whitelisted; and
dropping the data packet from the second app.

3. The method of claim 2, further comprising:
receiving, from the cellular network, a response to the data packet from the first app; and
providing the response to the first app.

4. The method of claim 1, further comprising:
retreiving a whitelist from a memory of the wireless mobile device,
wherein dropping the data packet comprises dropping the data packet if the app is not on the whitelist,
wherein transmitting the data packet comprises transmitting the data packet over the cellular data network if the app is on the whitelist.

5. The method of claim 4, further comprising:
retreiving a unique identifier for each app listed in the whitelist; and
inserting each unique identifier into an IP table.

6. The method of claim 4, further comprising:
receiving a user selection of an app package,
wherein the contents of the whitelist are based on the selected app package.

7. The method of claim 6,
wherein the app package is a social media app package and the contents of the whitelist comprise a list of social media apps.

8. The method of claim 1, further comprising:
obtaining a whitelist from a remotely located server,
wherein dropping the data packet comprises dropping the data packet if the app is not on the whitelist,
wherein transmitting the data packet comprises transmitting the data packet over the cellular data network if the app is on the whitelist.

9. A method on a wireless mobile device having both WiFi capability and cellular data capability, the method comprising:
receiving a user selection of a cellular plan that does not include cellular data; and
in response to the user selection, preventing data packets originating from apps on the mobile wireless device from being sent to the cellular data network except for one or more apps that are configured to assist the mobile wireless device during voice handovers between WiFi networks and cellular networks.

10. The method of claim 9, further comprising:
receiving data packets from an app on the wireless mobile device, wherein the data packets include state information of a voice call in which the wireless mobile device is participating; and
transmitting the data packets over the cellular network.

11. The method of claim 10, further comprising:
transitioning the voice call from a WiFi network to the cellular network.

12. The method of claim 9, further comprising:
receiving data packets from a second app on the wireless mobile device; and
dropping the data packets.

13. A wireless mobile device having both WiFi capability and cellular data capability, the wireless mobile device comprising a controller and a transceiver, wherein the controller is configured to:
receive a data packet from an app executing on the device;
if the app is not whitelisted and the wireless mobile device is not connected to a WiFi network, drop the data packet; and
if the app is whitelisted, transmit the data packet via the transceiver over the cellular network.

14. The wireless mobile device of claim 13, wherein the controller receives the data packet from a first app, which is whitelisted, the controller being further configured to:
transmit the data packet from the first app via the transceiver over the cellular network;
receive a data packet from a second app, which is not whitelisted; and
drop the data packet from the second app.

15. The wireless mobile device of claim 14, wherein the controller is further configured to:
receive, from the cellular network via the transceiver, a response to the data packet from the first app; and
provide the response to the first app.

16. The wireless mobile device of claim 13, further comprising a memory, wherein the controller is further configured to:
retreive a whitelist from the memory;
drop the data packet if the app is not on the whitelist; and
transmit the data packet via the transceiver over the cellular network if the app is on the whitelist.

17. The wireless mobile device of claim 16, wherein the controller is further configured to:
retrieve a unique identifier for each app listed in the whitelist; and
insert each unique identifier into an IP table.

18. The wireless mobile device of claim 16, wherein the controller is further configured to:
receive a user selection of an app package,
wherein the contents of the whitelist are based on the selected app package.

19. The wireless mobile device of claim 18,
wherein the app package is a social media app package and the contents of the whitelist comprise a list of social media apps.

20. The wireless mobile device of claim 13, wherein the controller is further configured to:
obtain a whitelist from a remotely located server,
drop the data packet if the app is not on the whitelist; and
transmit the data packet over the cellular data network if the app is on the whitelist.
